(19) United States
(12) Patent Application Publication
(10) Pub. No.: US 2020/0108422 A1
(43) Pub. Date: Apr. 9, 2020

(54) Restorative cleaning Process

(71) Applicant: John Gray, Thousand Oaks, CA (US)

(72) Inventor: John Gray, Thousand Oaks, CA (US)

(21) Appl. No.: 16/381,534

(22) Filed: Apr. 11, 2019

Related U.S. Application Data
(63) Continuation of application No. 15/279,285, filed on Sep. 28, 2016, now abandoned.
(60) Provisional application No. 62/234,007, filed on Sep. 28, 2015.

(51) Int. Cl. B08B 3/08; B08B 1/00; A47L 11/40

(52) U.S. Cl. CPC B08B 3/08; A47L 11/40; B08B 1/002

(57) ABSTRACT

The present invention is a deep cleaning process for carpets through its unique restorative cleaning process. The present comprises a use of restorative cleaning agent and cleansers according to the pH level of the stain, and a method either of agitating with hand-held polyester carpet brush or of rotary power scrubbing with polyester brush. Through its unique deep cleaning process including anti-ghost stain treatment to prevent the stain from re-appearing, the present invention will yield cleaner cleaning process than the industry standard cleaning method. In an alternative embodiment of the Restorative Cleaning Process of the present invention, man-made carpet fibers are cleaned using a series of cleaning steps designed to extract soil particulates from the fibers of the carpet and decrease the time it takes for the carpet to dry. In addition, an anti-reappearing ghost spot device utilizing the anti-reappearing ghost spot post-treatment is used to prevent spots from re-appearing.

### RELATED APPLICATIONS

The present application is a continuation-in-part of U.S. Utility patent application Ser. No. 15/279,285, entitled “Restorative Cleaning Process”, filed on Sep. 28, 2016, and currently co-pending, which claims the benefit of priority to U.S. Provisional Patent Application Ser. No. 62/234,007, entitled “Restorative Cleaning Process”, filed Sep. 28, 2015.

### FIELD OF THE INVENTION

The present invention relates generally to a carpet cleaning process that provides a restorative cleaning process and anti-ghost spot treatment preventing the stains from re-appearing. This invention particularly, though not exclusively, provides a method of deep cleaning which comprises a use of restorative cleaning agent and cleansers according to the pH level of the stain, and a method either of agitating by rotary power scrubbing with plain white micro fiber bonnet or by rotary power scrubbing with knap brush driver and green stripe micro fiber scrub bonnet. Through its unique cleaning process, the present invention will yield two (2) to three (3) times cleaner products than the industry standard cleaning method. Thus, carpets will remain clean two (2) to three (3) times longer than the industry standard cleaning. In addition, this restorative cleaning process dries two (2) to three (3) times faster than the industry standard cleaning. By adopting unique restorative cleaning process and anti-ghost spot treatment in its own unique order of application, the present invention takes all the pros, but eliminates all the cons of traditional carpet cleaning techniques in industry and proposes a new method of deep cleaning.

### BACKGROUND OF THE INVENTION

There are two (2) cleaning techniques that are most common in the cleaning industry. The first one is Hot Water Extraction “steam cleaning,” and the second one is low moisture bonnet cleaning “dry cleaning.” Both techniques have their pros and cons as well as their differences. The process in steam cleaning works by expelling a warm solution of water and detergent onto carpet.

A steam cleaner removes more than mere dirt from a carpet. The heat from the steam cleaner has an adverse effect on fleas and allergens such as dust mites. However, steam cleaning is meant to “wash” carpet rather than to remove solid items from it, thus, it works best on a carpet that is already mostly clean. This means that before you steam clean a carpet, you must first dry vacuum it thoroughly to remove debris. It could be time-consuming because you may spend a lot of time cleaning if you want to treat a large area. Also, the water tends to remain in the carpet for days and this water can then trap in more dirt and grime if it is used. Thus, there is a chance, if it does not dry thoroughly, that the moisture could lead to possible mold and bacteria growth. In addition, the heat necessary to do a proper steam can damage carpet fibers and destroy carpet base. Carpeting may pill and lose its visual appeal. If there is too much water in the steam cleaner, the suction from machine may not be enough to remove it all from the carpet.

Another most common technique of carpet cleaning is chemical dry cleaning, which uses a chemical cleaner rather than hot water. It uses microscopic carbonated bubbles to get deep into the carpet and then, with the help of carbonation, the dirt, stain and grime are extracted away. However, if the customers are anti-chemicals or the customers have small children or pets, they would prefer steam cleaning with just hot water and getting fairly good results to using chemicals. In addition, dry cleaning is usually more expensive than steam cleaning.

Both over-the-counter spot cleaners used by consumers and professional cleaning processes struggle with the later reappearance of removed spots. Although these resurfacing spots appear as a soiled area of the carpet, they are 100% of the time a layer of soap residue from an application of the alkaline cleaners used that were unconsciously left in the carpet fibers that attached and attracted like a soil magnet to the top and bottom of each and every pre-existing layer of sticky residue, dry and oily soils, and have wicked to the surface of the carpet fiber. The initial cleaner used is an emulsifier, generally with added degreaser, and often is alkaline with a pH of 7 or higher. Processes known in the art agitate the initial cleaner upon application in order to “loosen” the soil to remove the stain. However, the inertia from the application of applying the initial treatment combined with the agitating mechanism also pushes both the soil and the cleaner deeper into the carpet. This is particularly the case for soil and cleaner residue in the bottom half of the carpet fiber. Further cleaning continues to create layers of detergent in the carpet, making it impossible for cleaning processes known in the art to recover fallen residue and ever-increasing layers of cleaning agents, which causes the carpet fibers to feel sticky and kind of stiff and crunchy, and the pile to become matted. This has the further effect of damaging the integrity of the carpet fiber, including the stain guard coating commonly manufactured into the fiber. The destruction of the stain guard properties of carpet through known cleaning processes ultimately causes the carpet to lose its ability to be cleaned, thus shortening the carpet's lifespan.

Industry standard practice is to leave the carpet in a neutral or alkaline state at the end of the cleaning process. For example, U.S. Pat. No. 6,189,170 describes a process of cleaning carpet using basic cleaning agents, and then applying an acid conditioner to neutralize the bases, following an industry standard of leaving the carpet in a neutral pH of 7. However, leaving the carpet in a pH of 7 or higher is a recipe that over time through periodical interim care leads to the carpet fibers being totally inundated/filled with built up soap residue which causes the carpet fibers to look and feel not right, which ultimately shortens the lifespan of the fibers and damages their stain guard coating.

In the light of the above, it would be advantageous to propose a carpet cleaning method adopting all the pros from the two (2) most common carpet cleaning techniques and excused most of the cons. The present invention presents a very thorough, yet gentle cleaning process that helps make a carpet last longer and perform much better. The “Restorative Cleaning Process” in this invention is designed to helpprevent, correct, and restore problems or mistakes other professional and or do-it-yourself cleanings have left behind like “ghost spots” (re-appearing spots), rapid re-soiling areas and “kind of crunchy” carpets to name a few.

### SUMMARY OF THE INVENTION

The present invention is a deep cleaning process for carpets through its unique restorative cleaning process. The present invention includes use of restorative cleaning agent and cleansers according to the pH level of the stain, and a method either of agitating with rotary power scrubbing with a floor machine driver and a micro fiber bonnet or with a knap brush driver with a green stripe micro fiber scrub bonnet. Through its unique deep cleaning process including anti-ghost stain treatment to prevent the stain from re-appearing, the present invention will yield cleaner cleaning process than the industry standard cleaning method. Also, the present invention helps the carpets remain clean longer than the industry standard cleaning, while this restorative cleaning process dries faster than the industry standard cleaning. By adopting all the pros, but eliminating all the cons of traditional carpet cleaning techniques in industry, the present invention proposes a new and healthy method of deep cleaning of carpets.

In an alternative embodiment of the Restorative Cleaning Process of the present invention, man-made carpet fibers are cleaned using a series of cleaning steps designed to extract soil particulates from the fibers of the carpet and decrease the time it takes for the carpet to dry. In addition, an anti-reappearing ghost spot device utilizing the anti-reappearing ghost spot post-treatment is used to prevent spots from re-appearing.

Another preferred embodiment of a Restorative Cleaning Process of the present invention involves three cleaning cycles in addition to preliminary vacuuming, starting with a relatively pH-neutral cleaner in a low-moisture and low-pressure application followed by absorption or extraction, continuing with a high-moisture, high-heat, and high-pressure cycle with an acidic cleaner, and being finalized in a low-moisture, high heat, low-pressure cycle using an acidic cleaner. The process leaves the carpet in a slightly acetic state similar to the pH level the fibers have when the manufacturer ships them. In many cases, the process is able to restore carpet that the consumer considers worn out or ruined by removing the cleaning residues, soils, and oils left behind by previous cleaning processes.

### BRIEF DESCRIPTION OF THE DRAWINGS

FIG. 1 is a flow chart having a series of method steps for the Restorative Cleaning Process including the use of natural Restorative Cleaning Agent twice, and a very unique anti-ghost stain treatment process;

FIG. 2 is a flow chart having a series of method steps for the alternative embodiment of the Restorative Cleaning Process;

FIG. 3 is a flow chart illustrating three cycles of cleaning in a preferred embodiment of a Restorative Cleaning Process;

FIG. 4 is a flow chart illustrating the three cycles of cleaning of FIG. 3 as part of a complete cleaning process;

FIG. 5 is a flow chart illustrating steps in the low-moisture, low-pressure cycles of FIG. 3; and

FIG. 6 is a flow chart illustrating steps in the high-moisture, high-pressure cycle of FIG. 3.

### DETAILED DESCRIPTION OF THE INVENTION

### The Restorative Cleaning Process

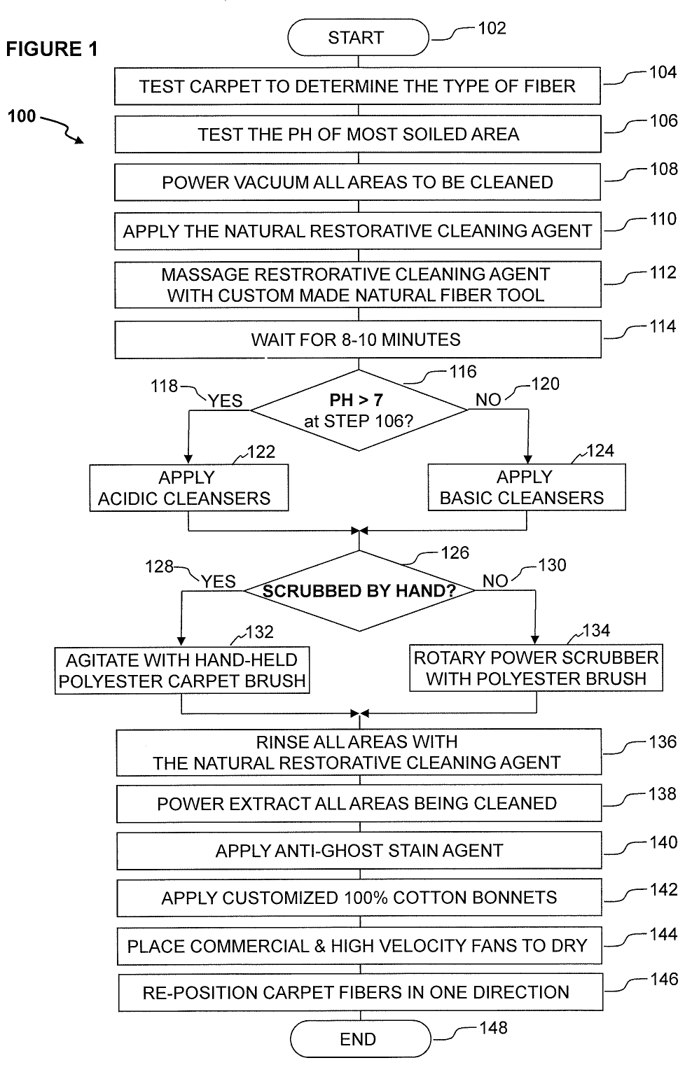

A flow chart of methods and steps of the Restorative Cleaning Process is illustrated in FIG. 1, which provides a use of the natural restorative cleaning agent and cleansers according to the pH level of the stain, a method either of rotary power scrubbing with a floor machine driver and a micro fiber bonnet or with a knap brush driver with a green stripe micro fiber scrub bonnet, and a unique anti-ghost stain treatment helping fix and prevent “ghost stains” from occurring. A flowchart exemplifying a restorative cleaning process, which helps carpets remain clean two (2) to three (3) times longer and carpets get dried two (2) to three (3) times faster than the industry standard cleaning, is illustrated as method 100.

The method starts at step 102 and follows to the first process 104 of testing carpet to determine the type of its fiber. After testing carpet and figuring out the type of fiber, the pH level of the most soiled area will be tested at step 106. According to the pH level tested here in step 106, different type of cleansers should be selected later. Then, power vacuum would be applied to clean the all areas that need to be cleaned at step 108. After cleaning all soiled areas in need of being cleaned, a natural restorative cleaning agent, a unique cleaning agent in this invention, is applied at step 110, to all areas that need to be cleaned. At step 112, the restorative cleaning agent is being gently massaged into carpet with high speed rotary scrubber and micro fiber bonnet or for moderate to heavy soiling conditions a high speed rotary scrubber with a knap brush driver and a green stripe micro fiber scrub bonnet, which is unique to the steam cleaning method. After massaging the restorative cleaning agent with a high speed rotary scrubber and micro fiber bonnet at step 112, one is directed to wait for 8-10 minutes at step 114 to let the natural restorative cleaning agent dwell.

Now, following the output path of step 114 leads into the decision stage 116, to decide whether the pH level of the stain tested at step 106 is greater than 7 or not. The selected cleaning agent should be the opposite of the tested pH level. If the pH level of the stain is greater than 7, this means the stain is basic or alkaline and via path 118, an acidic cleaning agent should be selected at step 122 to neutralize the stain. If the pH level is lower than 7, this means the stain is acidic. Here, via path 120, basic or alkaline cleaning agent should be selected at step 124 to neutralize the stain. In some cases, the strength of the cleaning agent can be matched to the strength of the stain. For example, the acidity of the cleaning agent to the alkalinity of the stain can be matched˜a stain of pH 8 will be cleaned with an acidic cleaning agent with a Ph 6.

After appropriate cleaning agent is selected, another decision stage 126 to decide whether the soiled carpet can be scrubbed by regular bonnet is followed. Here, how soiled the carpet is determined by whether it can be scrubbed by high speed rotary scrubber and regular bonnet or knap brush driver and a green stripe micro fiber scrub bonnet. If the carpet is scrubbed by regular bonnet, via path 128, it will be agitated with high speed rotary scrubber and micro fiber bonnet at step 132. If it is not scrubbed by bonnet, but by green stripe scrub bonnet, via 130, the carpet would be equipped with high speed rotary power scrubber with knap brush driver and green stripe micro fiber scrub bonnet at step 134.

Now referring to step 136, all areas will be rinsed one more time with the natural restorative cleaning agent, which already has been used at step 110. This is one of the primary advantages in the present invention that the natural restorative cleaning agent is used twice, once in the beginning and another time towards the end. After all of these cleaning steps comprising the initial application of the natural restorative cleaning agent at step 110, application of acidic or alkaline cleansers at step 122 or 124, and rinsing with the natural restorative cleaning agent again at step 136, all the areas being cleaned would be power extracted at step 138 which is unique to the dry cleaning method. In recognition of this unique technique, which is the first in industry adopting all of the pros in the most common cleaning techniques of steaming and dry cleaning, the present invention is nicknamed as “Triple The Clean” by the clients.

After getting through all of the thorough cleaning process, anti-ghost stain agent, which prevents the stain from reappearing, will be applied at step 140. Through this step, the furnishings on the carpet will be thoroughly stain-guarded to completely retard soiling with 1 year guarantee for spots or spills. After a thorough treatment for re-appearing stains on furnishings, the cleaned carpet should be dried. The present invention adopts two (2) steps for drying the carpet completely. The first drying step of step 142 is using customized 100% cotton bonnets. The 100% cotton bonnets will gently clean the furnishing even a little more and help drying process begin at the same time. Then, the second drying step of step 144 would be applied. At step 144, to expedite the drying even more, air movers, such as commercial or high velocity fans, will be placed in strategic locations. Throughout these two (2) steps, most furnishings will be completely dried.

After the furnishing is completely dried, the carpet fibers will be re-positioned at step 146, in one direction with polyester carpet groomer. Subsequently, the restorative cleaning process of the present invention is completed at step 148. Throughout the process, the present invention adopts the healthy home enhancement, an allergy relief treatment. Also, a professional strength sanitizer that kills 99.9% of all germs and bacteria in or on the furnishings, and a professional strength deodorizer to deodorize and refresh the furnishings are used in the present invention. Because the present invention results in helping the carpet last up to three (3) times longer than traditional “steam” or “dry” cleaning techniques, it helps enhance the furnishing's performance during its lifetime.

### An Alternative Embodiment of the Restorative Cleaning Process

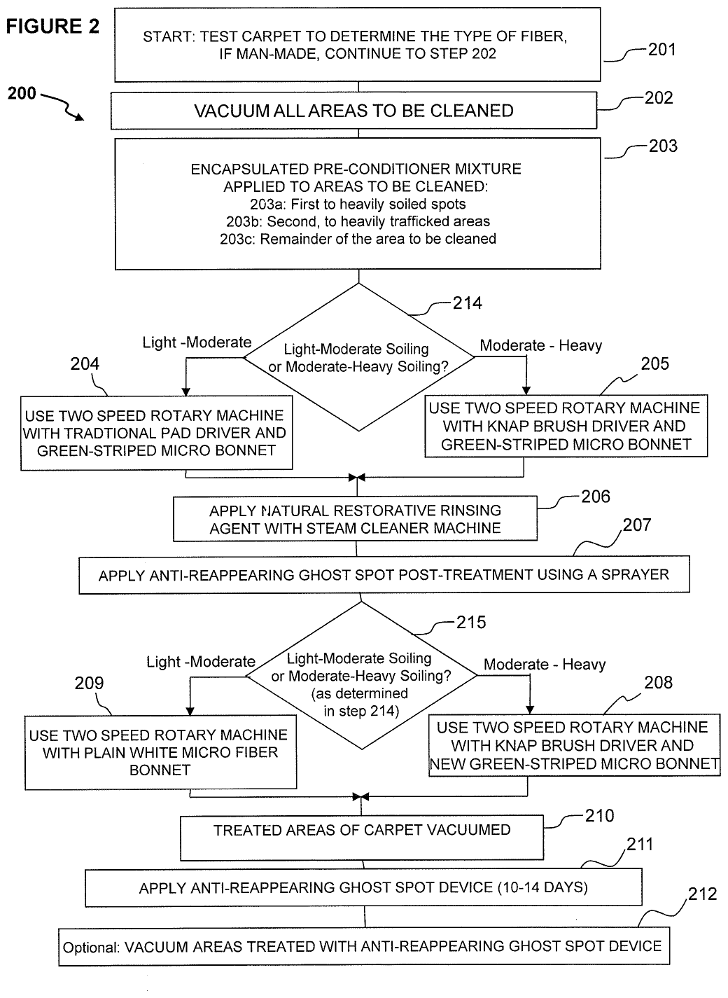

In another embodiment of the present invention 200, illustrated in FIG. 2, the process also begins with testing the carpet fiber 201 to determine whether the carpet consists of man-made fibers or naturally occurring fibers. Man-made fibers, such as synthetic fibers of polypropylene, nylon, polyester, etc. can be utilized by this invention. However, if the carpet consists of a natural fiber, such as wool, silk, etc., other cleaning processes, like those mentioned in the previous embodiment, should be utilized.

Once the user has determined that the carpet consists of man-made fibers, the user continues on to step 202, which requires that all areas to be cleaned be vacuumed prior to the use of any product. Vacuuming the area can help reduce the amount of dry particulate soil prior to the use of any chemical mixtures.

After the area is vacuumed in step 202 and all excess dirt removed, a mixture of encapsulated pre-conditioner, hydrogen peroxide (H₂O₂), and water is applied to the carpeted areas to be cleaned (Step 203). Encapsulated pre-conditioners suspend the particulate soil, emulsifying and forming a barrier around the soil in order to prevent the soil from being reabsorbed back into the carpet fibers. A non-limiting example of an encapsulated pre-conditioner used would comprise a degreaser, emulsifier, and have a pH of 7-10.

An example of a potential composition of the encapsulated pre-conditioner mixture would be twelve (12) fluid ounces of hydrogen peroxide per ten (10) fluid ounces of encapsulated pre conditioner, per three (3) gallons of water. While the encapsulated pre-conditioner mixture is described as having the aforementioned composition, it will be appreciated by those skilled in the art that deviation from this composition is not outside the scope of this invention.

The encapsulated pre-conditioner mixture is first applied to any heavily soiled spots 203a. Second, the encapsulated pre-conditioner mixture is applied to the main walkways or the most heavily trafficked areas 203b. Next, the encapsulated pre-conditioner mixture is applied to the remainder of the areas to be cleaned 203c. Applying the pre-conditioner mixture in this order allows the most heavily soiled areas to have more exposure time to the encapsulated pre-conditioner mixture.

Depending on the soiling conditions, the carpet is then agitated and the previous treatment is extracted from the treated carpet areas. No matter the soil level, the carpet is agitated using a two-speed, 175 revolutions-per-minute (RPM) rotary machine in the high speed setting. The two-speed rotary machine is utilized over a standard one-speed rotary machine because the two-speed rotary machine is heavier and spins faster, which allows the user to simultaneously extract the moisture of the treatment and agitate more soil from the carpet fibers.

The attachments used with the two-speed rotary machine depend on the soil conditions of the carpet area to be cleaned, which requires the user to determine whether the carpet area has light-moderate soiling or moderate to heavy soiling (Step 214). If the carpet has light to medium soiling conditions (Step 204), a traditional pad driver with a green striped micro fiber bonnet is used in conjunction with the two-speed rotary machine. The current state of the art suggests the use of the single speed rotary machines used in conjunction with a regular driver or carpet brush. This can lead to oversoaked carpets when the treatment penetrates to the bottom of the carpet fibers.

A green striped micro bonnet is a bonnet that includes a green polypropylene stripe, which is designed to provide added scrubbing power than with a traditional bonnet. Traditionally, bonnets are used on damp carpet. The green striped micro fiber bonnet simultaneously aggressively agitates, loosens, and extracts soil from the carpet fibers soils and moisture from the previous treatment. The combination of the extra weight of the machine, two-speed rotary machine, the regular driver, green striped bonnet, and the encapsulated pre-conditioner mixture, there is enough heat created to leave the fibers damp, not soaked. As bonnets are typically used in dry carpet cleaning practices, the use of the micro bonnet aids the user in limiting the amount of water left in the carpet fibers.

If the carpet has moderate to heavily soiling conditions (Step 205) the user must use a knap brush driver combined with a green striped micro fiber bonnet. In contrast with the regular driver used above, a knap brush driver agitates soil more effectively than a regular driver. The knap brush driver agitates soil and is extracted by the green striped micro fiber bonnet for use against heavily soiled areas.

As with light to moderately soiled carpets, the combined effect of using the knap brush, the green striped bonnet, and the heavy two-speed rotary floor machine in high speed, agitates, cleans, and extracts from the carpet fibers soils and moisture from the previous treatment. Using all components together simultaneously creates friction and heat, thus achieving a cleaner outcome and shorter drying period.

The next Step 206 in the alternative embodiment of the Restorative Cleaning Process 200 is to apply the natural restorative rinsing agent. The natural restorative rinsing agent comprises a mixture of acetic acid (CH₃COOH), water, and hydrogen peroxide. The concentration of each component of the natural restorative rinsing agent chemical composition can vary depending on the extent that the carpet is soiled. One non-limiting example of a potential combination of components is six (6) fluid ounces of 27% acetic acid and nine (9) fluid ounces of hydrogen peroxide, per three (3) gallons of water.

The components safely and naturally deodorize, sanitize, and neutralize, any pre-existing detergents from past cleanings, while still remaining baby and pet safe due to its natural components. As stated above, the relative concentration of any of the components can be altered depending on the extent of the soiled carpet. For example, if the carpet is heavily soiled, a higher concentration of acetic acid and hydrogen peroxide may be used. As a non-limiting example composition, for moderate to heavily soiled carpets, 9 fluid ounces of 27% acetic acid and 9 fluid ounces of hydrogen peroxide, per 3 gallons of water may be used. Given the composition of the natural restorative rinsing agent, it is particularly useful in reducing or removing permanent stains that are acidic or protein in nature.

The natural restorative rinsing agent is used with a hot water extraction carpet cleaning machine, otherwise known as a steam cleaner. The cleaning area is rinsed and the previous treatment extracted using this process.

After the natural restorative rinsing agent is used, the anti-reappearing ghost spot post-treatment is then applied to the carpet area using a 60 pounds per square inch (hereinafter “PSI”) sprayer 207. Although the anti-reappearing ghost spot post-treatment is applied using a 60 PSI sprayer, it will be understood by those skilled in the art that varying sprayers may be used. The anti-reappearing ghost spot post-treatment is a mixture of surfactants blended with fluoro-chemicals and hydrogen peroxide. Surfactants are compounds that have various cleaning properties. As a detergent, surfactants are used to unfold and solubilize proteins. While a variety of surfactants exist and may be used, the anti-reappearing ghost spot post-treatment works best with non-ionic surfactants. Non-ionic surfactants include, but are not limited to, cetyl alcohol, polyethylene glycol, etc.

Fluoro-chemicals are chemicals contain fluorine, such as fluoropolymers, fluoroelastomers, and fluoroelastomers and fluorocarbons. A non-limiting example of a potential fluoro-chemical that may be used in the anti-reappearing ghost spot post-treatment is perfluorobutanesulfonic acid, which is a fluorocarbon with a sulfonic acid functional group. This fluorocarbon acts as a fluorosurfactant due to the fluorine-carbon bonds.

The anti-reappearing ghost spot post-treatment's chemical composition can vary depending on the desires of the user. A non-limiting example of a potential composition of the anti-reappearing ghost spot post-treatment comprises one (1) gallon of fluoro-chemical, eight (8) fluid ounces of hydrogen peroxide, three (3) fluid ounces of surfactant, to one (1) gallon of water.

Once the anti-reappearing ghost spot post-treatment has been sprayed over the desired area, the anti-reappearing ghost spot post-treatment is massaged, distributed, and set using a two-speed 175 RPM rotary floor machine in high-speed. In conjunction with the rotary floor machine, the user may use either a plain white micro fiber bonnet (Step 209), or the knap brush driver and green striped micro fiber bonnet (Step 208) depending on the soil levels of the carpet, which is determined in Step 215. The determination in Step 215 depends on the result of Step 214. If in Step 214 the carpet was determined to have light to moderate soil conditions (Step 204), then a plain white micro fiber bonnet 209 is used. If in Step 214 the carpet was determined to have moderate-heavy soil levels (Step 205), the knap brush driver and green striped micro fiber bonnet 208 should be used. While the knap brush of Step 205 may be utilized again for 208, the green striped micro fiber bonnet utilized in step 205 should be replaced.

The anti-reappearing ghost spot post-treatment's unique formula penetrates deep into the fibers crystalizing, neutralizing, suspending, and dissolving build-up and protecting fibers from future stains. The previous steps of the alternative embodiment of the Restorative Cleaning Process 200 enable the anti-reappearing ghost spot post-treatment to leverage the natural occurring process called wicking to effectively achieve lifting from the base and the backing of the carpet, the soap residues, spots, stains, and traffic lanes that had penetrated to the base of the carpet.

The weight of the rotary machine and the speed of the turning bonnets insure the treatment is heat set and distributed to the entire fiber. Because of the heat friction created by the machine and bonnet, the micro fiber bonnet's ability to absorb moisture, and the chemical composition of the treatment, leaves the carpet damp to the touch and, not soaking wet.

In Step 210, the treated area is vacuumed once again in order to successfully remove any crystallized and suspended soil from previous steps.

As mentioned in the previous embodiment, “ghost spots” can reappear after the carpet has been cleaned. In Step 211, an anti-reappearing ghost spot device is left on the most problematic areas that have been known to resurface in the past, and left there, untouched, for ten (10)-fourteen (14) days.

The anti-reappearing ghost spot device is a cloth soaked in the anti-reappearing ghost spot post-treatment of Step 207 and then dried. Leaving the anti-reappearing ghost spot device on areas prone to “ghost spots” will dissolve any soil still left in the carpet after previous steps. In addition to laying the anti-reappearing ghost spot device upon the carpet, a light book or weight can be used to both secure the anti-reappearing ghost spot device to the location, and also help expose the anti-reappearing ghost spot device to more surface area of the carpet. The anti-reappearing ghost spot device is then removed after the allotted ten (10)-fourteen (14) days.

In an optional additional Step 212, the user can choose to vacuum the area underneath any anti-reappearing ghost spot devices in order to remove any crystallized or suspended soil particulates.

The Steps of the alternative embodiment of the Restorative cleaning process are designed to clean the entire fiber (top to bottom) of the carpet and prevent any reappearing “ghost” spots, thereby extending the life of the carpet.

### Another Preferred Embodiment of a Restorative Cleaning Process

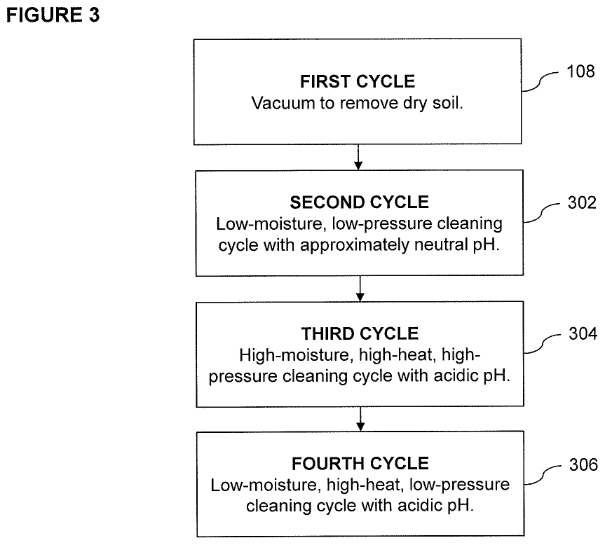

Illustrated in FIGS. 3-6 is a preferred embodiment of a Restorative Cleaning Process that includes four complete cycles of cleaning. The cycles include vacuuming to remove the dry soil and the various combinations of high heat (or “high temperature”) (above two-hundred degrees Fahrenheit) and high pressure (above 300 PSI) hot water extraction with high suction or low (moisture) pressure (100 PSI or less).

Referring now to FIG. 3, a preferred embodiment of a Restorative Cleaning process includes a second cycle 302 of cleaning, generally performed after an initial vacuuming 108, in which second cycle 302 a pH neutral or slightly alkaline cleaning agent is used in a low-moisture, low-pressure application and extraction. Ideally, the cleaning agent in the second cycle 302, which has a pH between 7 and 10, inclusive, is applied at or near 100 PSI using a fan tip on the end of the spraying mechanism so the initial pre-treatment only moistens the top third of the fiber. This second cycle 302 removes the surface soil that is on top of and attached to the preexisting residue layer underneath it, so that the act of removing this layer of soil and preconditioner clears the top third of the carpet fiber of contaminates, preparing the way for cleaning the middle third of the fiber in the third cycle 304.

In the third cycle 304 of cleaning, a hot water extraction (“HWE”) is performed with an acidic cleaning agent of pH between 3 and 6, inclusive, and preferably at or about 4.7. The third cycle 304 is a high-moisture, high-heat, high-pressure, and high suction/extraction cleaning cycle, using a water or solution temperature between 220- and 240-degrees Fahrenheit, inclusive, injected at a pressure between 350 and 400 PSI, inclusive. The rinsing and extracting performed in the third cycle 304 removes the preexisting layer of soap residue and the remnants of soil and oil that are attached to it in the middle third portion of the fiber that is found underneath the top coat of soil, which now prepares the lower third and base of the fiber for the fourth cycle 306 of cleaning.

The fourth cycle 306 of cleaning uses an acidic cleaning agent of pH between 3 and 6, inclusive, and preferably about 4.7, in a low-moisture, low-pressure, high-heat application. The temperature of the solution applied is between 220- and 240-degrees Fahrenheit, inclusive, at a pressure of or about 60 PSI, using a fan tip on the end of the spraying mechanism so the application of the final treatment treats the bottom third of the fiber as well as the total carpet strand. The solution is an anti-reappearing ghost spot treatment made with a combination of acetic acid, hydrogen peroxide, an encapsulating cleaning agent, fluorochemical urethane, and water. The treatment is acid-based, includes encapsulant and a stain guard. Since the top two-thirds of the fiber has been cleared, this fourth cycle 306 is able to capture the preexisting residue, soil, and oil that is attached to the bottom third and base of the fiber and lifting it up through vacuuming as well as by leveraging the naturally occurring process of wicking, all while replenishing to the total fiber the stain guard.

As a result of the four cycles, 108, 302, 304, and 306, the carpet is left in a slightly acidic state at the end of the cleaning process, which is approximately the same pH level of the carpet fibers at the time the manufacturer shipped them. This avoids weakening the carpet fibers and damaging the stain guard coating applied during manufacturing, thus lengthening the carpet's lifespan beyond that of carpets treated by currently known processes in the industry. After performance of the restorative cleaning process described herein, a treated carpet generally has a pH of between 5.5 and 6.5, inclusive.

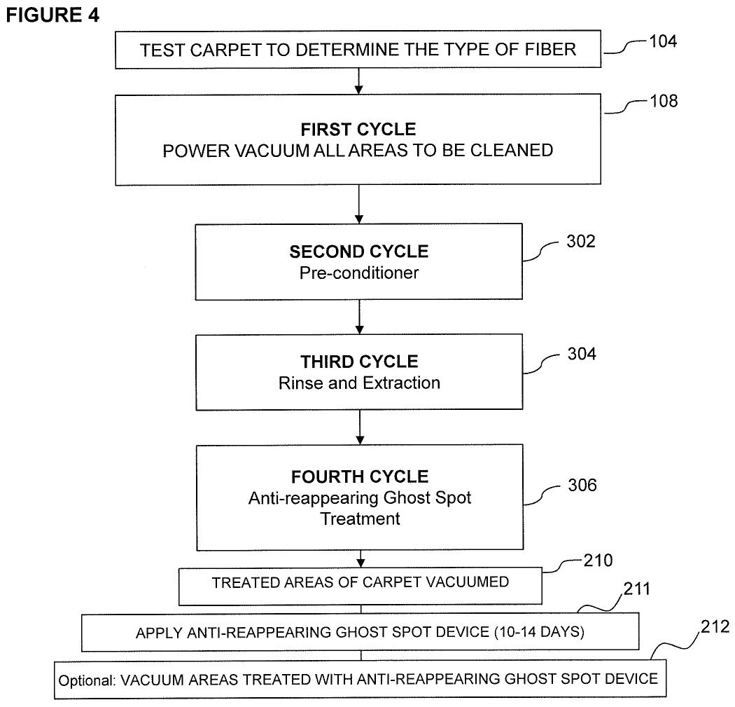

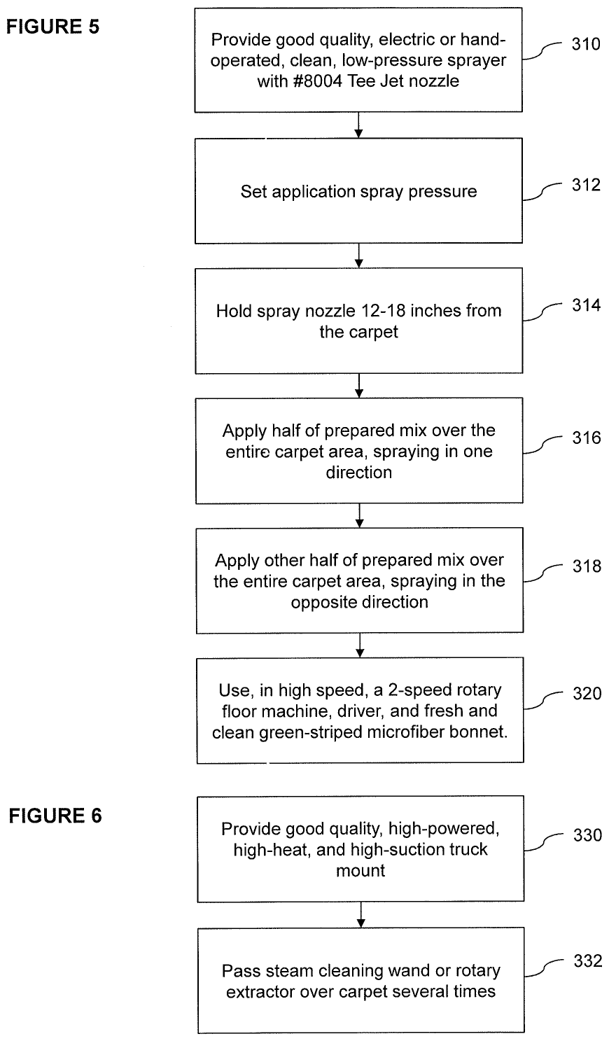

FIG. 4 illustrates how the four cleaning cycles may be integrated into an overall cleaning process including steps discussed above in connection with FIGS. 1 and 2. Carpet fiber testing and vacuuming may be performed initially, as described in steps 104 and 108 of FIG. 1, or steps 201 and 202 of FIG. 2. The second cycle 302 is then performed and may be characterized as applying a pre-conditioner, as illustrated. Cycle 302 and cycle 306 include agitation and absorption with a rotary machine and bonnet, as discussed in connection with FIG. 5, below. The third cycle 304, characterized here as a rinse and extraction, is then performed, followed by the fourth cycle 306. Additional steps to finalize the process, such as steps 144 and 146 from FIG. 1, or steps 210 through 212 from FIG. 2, may then be performed. The same mixtures for pre-conditioners, restorative rinsing agents, and anti-reappearing ghost spot treatments (or post-treatments) described in the other embodiments herein are also used in some preferred embodiments of the second cycle 302 pre-conditioner, the third cycle 304 rinse, and the fourth cycle 306 anti-reappearing ghost spot treatment, respectively.

Referring now to FIG. 5, steps common to the low-pressure cleaning cycles 302 and 306 are illustrated. In step 310, a good quality, electric or hand-operated clean low-pressure sprayer is provided. In preferred embodiments, a #8004 Tee Jet nozzle is used. In step 312, a predetermined spray pressure is selected. For the second cycle 302, a pressure of 100 PSI is preferred, while in the fourth cycle 306, a pressure of 60 PSI is preferred. The spray nozzle is held 12-18 inches from the carpet during application, as illustrated in step 314. The prepared cleaning solution for the cycle is applied; first, half of the solution is applied by spraying in one direction over the entire area of carpet being cleaned, as illustrated in step 16. Then, the remaining half of the solution is applied by spraying in the opposite direction over the same entire area of carpet being cleaned, as illustrated in step 318. Afterward, in step 320, a two-speed rotary floor machine is used over the sprayed areas. Two attachments are used with the rotary machine. In the second cycle 302, the attachments are a nap brush driver and a fresh and clean green-striped microfiber bonnet, which causes the dampened areas to be simultaneously agitated and the moisture, soap residues, and soils absorbed or extracted. In the fourth cycle 306, the attachments are a regular pad driver and a fresh and clean green-striped microfiber bonnet, which causes the last treatment to be simultaneously massaged and heat set in between the high temperature solution, the high-RPM rotations, and the hundred pounds of force from the physical weight of the rotary machine itself.

Referring now to FIG. 6, steps in the third cleaning cycle 304 are illustrated. Step 330 provides a good quality, high-powered, high-heat, and high-suction truck mount. Step 332 involves passing a steam-cleaning wand or rotary extractor several times over the surface of the carpet areas being cleaned. This causes hot water or cleaning solution to be injected into the fibers of the carpet at high pressure, and to be removed by a powerful vacuum, thereby rinsing and extracting out the soils and residues from the carpet fibers, and specifically the middle and lower portions of the carpet fibers.

While there have been shown what are presently considered to be preferred embodiments of the present invention, it will be apparent to those skilled in the art that various changes and modifications can be made herein without departing from the scope and spirit of the invention.

What is claimed is:

1. A restorative cleaning process, comprising the steps of:
selecting a carpet area to be cleaned;
performing a second cycle comprising:
applying a pre-conditioner having a pH of 7-10 to the carpet area,
agitating the pre-conditioner, and
extracting the pre-conditioner from the carpet area;
performing a third cycle comprising:
applying a rinse having a pH of 3-6 to the carpet area, and
extracting the rinse; and
performing a fourth cycle comprising applying an anti-reappearing ghost spot treatment having a pH of 3-6 to the carpet area.

2. The restorative cleaning process as recited in claim 1, wherein the pre-conditioner is applied at low pressure, the rinse is applied at high pressure and high heat, and the anti-reappearing ghost spot treatment is applied at low pressure and high heat.

3. The restorative cleaning process as recited in claim 2, wherein the rinse is applied at 350-400 PSI and 220-240 degrees Fahrenheit.

4. The restorative cleaning process as recited in claim 3, wherein the pre-conditioner is applied at 100 PSI.

5. The restorative cleaning process as recited in claim 4, wherein the anti-reappearing ghost spot treatment is applied at 60 PSI and 220-240 degrees Fahrenheit.

6. The restorative cleaning process as recited in claim 2, wherein the fourth cycle further comprises the step of massaging and heat-setting the anti-reappearing ghost spot treatment with a two-speed rotary floor machine with a regular pad driver and a green-striped microfiber bonnet.

7. The restorative cleaning process as recited in claim 6, wherein the extracting step of the second cycle comprises agitating and absorbing the pre-conditioner with a two-speed rotary floor machine with a nap brush driver and a green-striped microfiber bonnet.

8. The restorative cleaning process as recited in claim 1, wherein the carpet area is left in an acidic state upon completion of the process.

9. The restorative cleaning process as recited in claim 8, wherein the carpet area has a pH of 5.5-6.5 upon completion of the process.

10. The restorative cleaning process as recited in claim 1, wherein the pre-conditioner comprises a degreaser and emulsifier.

11. The restorative cleaning process as recited in claim 1, wherein the rinse comprises a mixture of acetic acid, water, and hydrogen peroxide.

12. The restorative cleaning process of claim 11, wherein the rinse comprises six fluid ounces of 27% acetic acid and nine fluid ounces of hydrogen peroxide per three gallons of water.

13. The restorative cleaning process of claim 11, wherein the rinse comprises nine ounces of hydrogen peroxide by volume per three gallons of water.

14. The restorative cleaning process of claim 1, wherein the anti-reappearing ghost spot treatment comprises a mixture of surfactants blended with fluoro-chemicals and hydrogen peroxide.

15. The restorative cleaning process of claim 1, wherein the anti-reappearing ghost spot treatment comprises a mixture of acetic acid, hydrogen peroxide, an encapsulating cleaning agent, fluorochemical urethane, and water.

16. A restorative cleaning process, comprising the steps of:
testing a carpet to determine the type of fiber;
performing a first cycle of cleaning comprising vacuuming the carpet;
performing a second cycle of cleaning using a pre-conditioner;
performing a third cycle of cleaning using a rinse;
performing a fourth cycle of cleaning using an anti-reappearing ghost spot treatment;
vacuuming the cleaned carpet; and
leaving the carpet in an acidic state at the end of the restorative cleaning process.

17. The restorative cleaning process as recited in claim 16, wherein the step of leaving the carpet in an acidic state comprises leaving the carpet with a pH of 5.5-6.5.

18. The restorative cleaning process as recited in claim 16, wherein the anti-reappearing ghost spot treatment comprises a formula that captures preexisting residue, soil, and oil attached to a bottom third and base of fibers of the carpet, causing the preexisting residue, soil, and oil to be lifted up through vacuuming and wicking.

19. The restorative cleaning process as recited in claim 16, wherein the second cycle of cleaning comprises a low-pressure application of pre-conditioner, the third cycle of cleaning comprises a high-pressure application of rinse, and the fourth cycle of cleaning comprises a low-pressure application of anti-reappearing ghost spot treatment.

20. The restorative cleaning process as recited in claim 19, wherein the third cycle of cleaning is performed with the rinse at a high temperature, and the fourth cycle of cleaning is performed with the anti-reappearing ghost spot treatment at a high temperature.
